(19) United States
(12) Patent Application Publication
(10) Pub. No.: US 2025/0091233 A1
(43) Pub. Date: Mar. 20, 2025

(54) Easy-to-Maintain and Elasticity-Adjustable Knife

(71) Applicant: Junjing Luo, Emeishan (CN)

(72) Inventor: Junjing Luo, Emeishan (CN)

(21) Appl. No.: 18/969,445

(22) Filed: Dec. 5, 2024

(30) Foreign Application Priority Data
Oct. 24, 2024 (CN) 202422571254.0

(51) Int. Cl. B26B 1/10; B26B 1/04

(52) U.S. Cl. CPC B26B 1/10; B26B 1/048

(57) ABSTRACT

An easy-to-maintain and elasticity-adjustable knife comprises a blade, a pair of liners and a pair of pull rod springs. The liners are connected by means of spacer sleeves, a stop rod is arranged in a first mounting clearance, an end, opposite to a blade tip, of the blade is connected to the liners by means of a spindle, sliding slots are formed in corresponding positions of the liners, and a pull rod is mounted in the sliding slots. An arc tip is arranged at the end, where the spindle is arranged, of the blade, a first clamping groove is formed in one side of the arc tip, and a second clamping groove is formed in the other side of the arc tip. The force of the pull rod can be easily adjusted without disassembling the whole knife, and the knife is easy to maintain.

### BACKGROUND OF THE INVENTION

### Technical Field

The invention relates to the technical field of knives, in particular to an easy-to-maintain and elasticity-adjustable knife.

### Description of Related Art

Although knives are dangerous to use, they bring much convenience in daily life as long as they are properly used. Cross bar lock folding knives, a blade of which can be received in a handle, are easy to store and carry, thus being popular with related users and particularly suitable for outdoor life. The blade of the cross bar lock folding knives, which are one type of folding knives, can be automatically and quickly pushed out of the handle by means of the resilience of a spring arranged between the blade and the handle.

At present, to adjust the force (elasticity) of a pull rod of an existing cross bar lock folding knife, spindle nail screws and screws for fixing a spacer sleeve need to be detached, and then the force of the pull rod is adjusted by adjusting receding positions of pull rod springs, such that DIY replacement of the handle can be easily achieved without disassembling the internal structure. However, such a structural design has the following problems:

First, when the folding knife is reassembled, it is difficult to assemble together all components of the folding knife under the action of the elastic force of the pull rod springs, leading to low assembly efficiency; second, when the folding knife is maintained and switched to a different usage mode later, the process of adjusting the force of the pull rod is complex, and multiple components have to be disassembled to adjust the pull rod springs; third, for a calibrated folding knife, after spindle nails are removed for adjusting the force of the pull rod, the folding knife needs to be reassembled and recalibrated, thus greatly reducing usage experience.

### BRIEF SUMMARY OF THE INVENTION

In view of the defects in the prior art, the purpose of the invention is to provide an easy-to-maintain and elasticity-adjustable knife.

To fulfill the above purpose, the invention adopts the following technical solution:

An easy-to-maintain and elasticity-adjustable knife comprises a blade, a pair of liners and a pair of pull rod springs, wherein the liners are connected by means of spacer sleeves to form a first mounting clearance between the liners, the blade is received in the first mounting clearance, a stop rod is arranged in the first mounting clearance, an end, opposite to a blade tip, of the blade is connected to the liners by means of a spindle, sliding slots are formed in corresponding positions of the pair of liners, a pull rod is mounted in the sliding slots and is able to slide back and forth along the sliding slots, a recess allowing the pull rod to retreat therein temporarily is formed in an end of each sliding slot, one end of each pull rod spring is provided with a barbed portion, the other end of each pull rod spring is bent to form an insertion end, insertion holes are formed in the liners, at least two insertion positions are arranged in each insertion hole, sockets are formed in two ends of the pull rod, the barbed portions of the pull rod springs are hooked in the sockets, and the insertion end of each pull rod spring is selectively inserted into one insertion position;
an arc tip is arranged at the end, where the spindle is arranged, of the blade, a first clamping groove is formed in one side of the arc tip, a second clamping groove is formed in the other side of the arc tip, and under the action of the pull rod springs, a rod body of the pull rod keeps abutting against the arc tip.

Preferably, handles are detachably mounted on outer surfaces of the liners, receding holes are formed in positions, corresponding to the sliding slots, of the handles, and second mounting clearances are reserved between inner surfaces of the handles and the liners and correspond to the pull rod springs.

Preferably, the handles are mounted on the liners with screws.

Preferably, a push button used by users to push the blade to rotate is arranged at a position close to a back of the blade, and the push button is uncovered.

Preferably, a top of the push button is mushroom-shaped and provided with a first anti-slip surface.

Preferably, second anti-slip surfaces are arranged on a back of the blade and side surfaces of the liners.

Preferably, a clip is arranged on one handle.

By adopting the above technical solution, when the force of the pull rod is adjusted, it is unnecessary to disassemble all components of the knife, only the handles need to be disassembled to directly uncover the pull rod springs, and then, the force of the pull rod can be easily adjusted by inserting the insertion ends into different insertion positions; moreover, the pull rod springs, as the most vulnerable parts, are assembled by hooking the barbed portions in the sockets, such that the pull rod springs can be replaced easily and conveniently, thus facilitating maintenance.

### BRIEF DESCRIPTION OF THE SEVERAL VIEWS OF THE DRAWINGS

FIG. 1 is a schematic structural view according to one embodiment of the invention.

FIG. 2 is a schematic structural view in a case where a blade is retracted according to one embodiment of the invention.

FIG. 3 is a schematic structural view in a case where the blade is stretched according to one embodiment of the invention.

FIG. 4 is a schematic structural view of a part corresponding to a pull rod spring according to one embodiment of the invention.

FIG. 5 is a schematic structural view in a case where handles are removed according to one embodiment of the invention.

### DETAILED DESCRIPTION OF THE INVENTION

To better clarify the purposes, technical solutions and advantages of the invention, the invention is described in further detail below in conjunction with accompanying drawings and embodiments. It should be understood that the specific embodiments described here are merely used for explaining the invention rather than limiting the invention.

In the description of the invention, it should be understood that terms “central”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise” and “anticlockwise” are used to indicate directional or positional relations based on the accompanying drawings merely for the purpose of facilitating and simplifying the description of the invention rather than indicating or implying that devices or elements referred to must be in a specific direction or be configured and operated in a specific direction, and thus should not be construed as limitations of the invention. In addition, terms “first” and “second” are merely used for the purpose of description and should not be construed as indicating or implying relative importance or implicitly indicating the number of technical features referred to. Therefore, a feature defined by “first” or “second” may explicitly or implicitly indicate the inclusion of one or more said feature. In the description of the invention, “multiple” refers to two or more, unless otherwise expressly defined.

In the description of the invention, it should be noted that, unless otherwise expressly stated and defined, terms “mount”, “link” and “connect” should be broadly understood. For example, “connect” may refer to a fixed connection, detachable connection or integrated connection; or, mechanical connection or electrical connection; or, direct connection, indirect connection by means of an intermediate medium, internal connection or interaction of two elements. Those ordinarily skilled in the art can appreciate the specific meanings of these terms in the invention as the case may be.

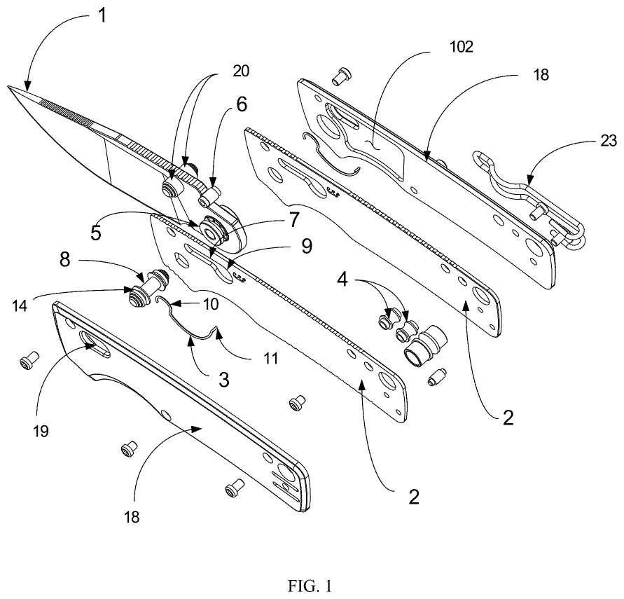

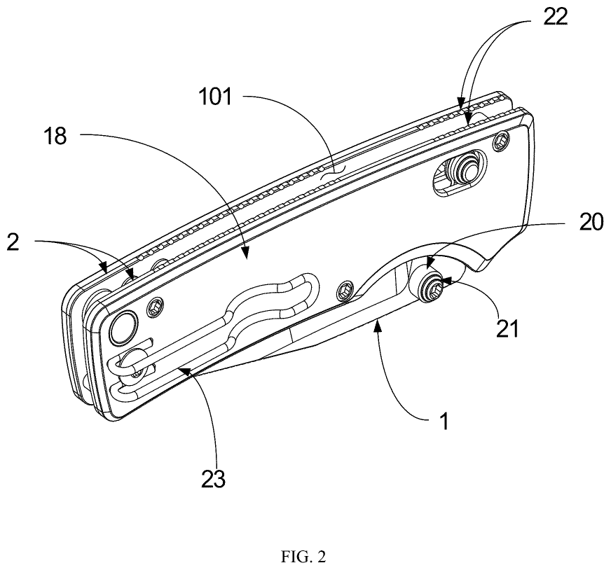

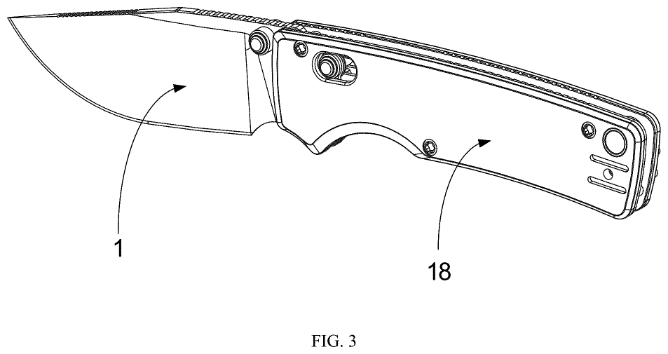

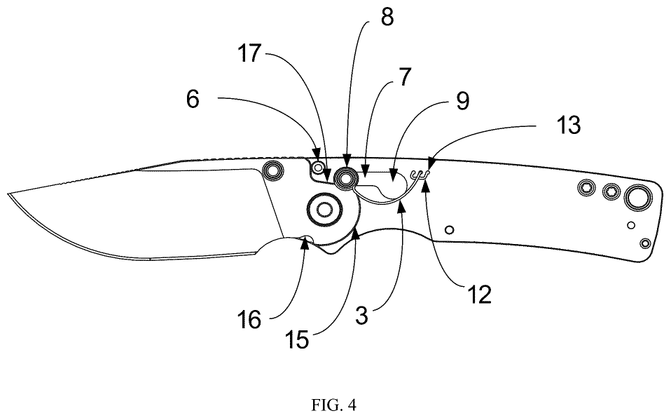

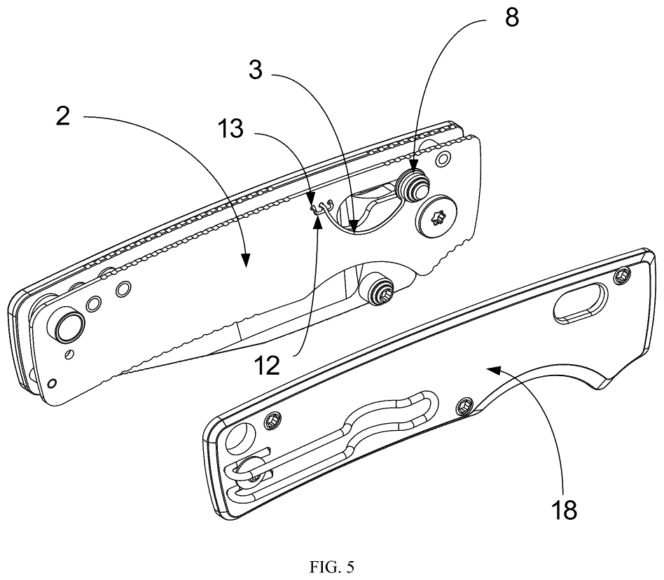

As shown in FIGS. 1-5, this embodiment provides an easy-to-maintain and elasticity-adjustable knife, comprising a blade 1, a pair of liners 2 and a pair of pull rod springs 3, wherein the liners 2 are connected by means of spacer sleeves 4 to form a first mounting clearance 101 between the liners 2, the blade 1 is received in the first mounting clearance 101, an end, opposite to a blade tip, of the blade 1 is connected to the liners 2 by means of a spindle 5, a stop rod 6 is arranged in the first mounting clearance 101, sliding slots 7 are formed in corresponding positions of the pair of liners 2, a pull rod 8 is mounted in the sliding slots 7 and is able to slide back and forth along the sliding slots 7, a recess allowing the pull rod 8 to retreat therein temporarily is formed in one end of each sliding slot 7, a barbed portion 10 is arranged at one end of each pull rod spring 3, the other end of each pull rod spring 3 is bent to form an insertion end 11, insertion holes 12 are formed in the liners 2, at least two insertion positions 13 are arranged in each insertion hole 12, sockets 14 are formed in two ends of the pull rod 8, the barbed portions 10 of the pull rod springs 3 are hooked in the sockets 14, and the insertion end 11 of each pull rod spring 3 is selectively inserted into one insertion position 13;
an arc tip 15 is arranged at the end, where the spindle 5 is arranged, of the blade 1, a first clamping groove 15 is formed in one side of the arc tip 15, a second clamping groove 17 is formed in the other side of the arc tip 15, and under the action of the pull rod springs 3, a rod body of the pull rod 8 keeps abutting against the arc tip 15.

Further, to enable the knife to be held more comfortably, in this embodiment, handles 18 are detachably mounted on outer surfaces of the liners 2, receding holes 19 are formed in positions, corresponding to the sliding slots 7, of the handles 18, and second mounting clearances 102 are reserved between inner surfaces of the handles 18 and the liners 1 and correspond to the pull rod springs 3. Specifically, the handles 18 are mounted on the liners 2 with screws. In this way, the knife can be held more comfortably; the spindle 5 on the blade 1 is hidden and neither penetrates through the handles 18 nor is fixedly connected to the handles 18, such that the handles 18 can be replaced easily without assembling and disassembling a rotating mechanism (the spindle 5), and the situation where the overall structural stability is affected due to assembly and disassembly of a pivot of a traditional knife is avoided; moreover, by adopting such a structure, personalized DIY requirements for the decorative handles 18 can be better satisfied, handles 18 which are made from different materials and have different patterns can be used without affecting the internal motion mechanism, users can replace the handles 18 with other different handles 18 by themselves, and operation is easy and convenient.

In this embodiment, when the force of the pull rod is adjusted, it is unnecessary to disassemble all components of the knife, only the handles 18 need to be disassembled to directly uncover the pull rod springs 3, and then, the force of the pull rod can be easily adjusted by inserting the insertion ends 11 into different insertion positions 13; moreover, the pull rod springs 3, as the most vulnerable parts, are assembled by hooking the barbed portions 10 in the sockets 14, such that the pull rod springs 3 can be replaced easily and conveniently, thus facilitating maintenance.

In specific use of the knife in this embodiment, the blade 1 is in a retracted state by default, and the pull rod 8 is located in the first clamping groove 16. When the blade 1 needs to be pushed out, the blade 1 is pushed to rotate outwards; in the rotation process of the blade 1, the arc tip 15 of the blade 1 keeps abutting against the pull rod 6 to drive the pull rod 8 to move in the sliding slots 7, and at this moment, the pull rod springs 3 will deform; when the pull rod 8 is pushed back into the recesses 9, the vertex of the longest edge of the arc tip 15 exactly abuts against the pull rod 8, the blade 1 is further rotated until the longest edge of the arc tip 15 is separated from the pull rod 8, at this moment, the pull rod 8 will be pushed into the second clamping groove 17 under the action of a reactive force of the deformed pull rod springs 3, and the blade 1 is limited by the pull rod 8 and pressed by the stop rod 6, thus being prevented from further rotation. When the blade 1 needs to be retracted, the blade 1 is pushed to rotate backwards, then the pull rod 8 is pushed to retreat, and the pull rod springs 3 deform again until the pull rod 8 returns into the first clamping groove 16, such that the blade 1 is retracted.

Wherein, the spindle 5 and the liners 2 are assembled threadedly. For example, the spindle 5 may be designed with spindle nails, bearings, and spindle nail screws. The threaded assembly is a conventional mechanical installation form and thus will not be detailed in this embodiment.

Further, to allow users to push the blade 1 to rotate by hand, in this embodiment, a push button 20 used by users to push the blade 1 to rotate is arranged at a position close to a back of the blade 1, and the push button 20 is uncovered. In this way, when the blade 1 needs to be pushed out, users can push the blade 1 to rotate outwards with their thumb by means of the push button 20.

Further, to fulfill an anti-slip effect, in this embodiment, the top of the push button 20 is mushroom-shaped and provided with a first anti-slip surface 21, and the first anti-slip surface 21 may be a helical surface or step surface.

Further, to prevent the knife from slipping out of user's hands in use, in this embodiment, second anti-slip surfaces 22 are arranged on the back of the blade 1 and side surfaces of the liners 2, and the second anti-slip surfaces 22 may be saw-toothed strips.

In addition, to ensure that the knife can be carried easily, in this embodiment, a clip is arranged on one handle 18, and the knife can be clipped on a backpack, a pocket, a belt or other small articles by means of the clip 23.

The above embodiments are merely preferred ones of the invention and are not intended to limit the patent scope of the invention. All equivalent structure or flow transformations made based on the above description and accompanying drawings, or direct or indirect applications to other related technical fields should also fall within the patent protection scope of the invention.

What is claimed is:

1. An easy-to-maintain and elasticity-adjustable knife, comprising a blade, a pair of liners and a pair of pull rod springs, wherein the liners are connected by means of spacer sleeves to form a first mounting clearance between the liners, the blade is received in the first mounting clearance, a stop rod is arranged in the first mounting clearance, an end, opposite to a blade tip, of the blade is connected to the liners by means of a spindle, sliding slots are formed in corresponding positions of the pair of liners, a pull rod is mounted in the sliding slots and is able to slide back and forth along the sliding slots, a recess allowing the pull rod to retreat therein temporarily is formed in an end of each said sliding slot, one end of each said pull rod spring is provided with a barbed portion, the other end of each said pull rod spring is bent to form an insertion end, insertion holes are formed in the liners, at least two insertion positions are arranged in each said insertion hole, sockets are formed in two ends of the pull rod, the barbed portions of the pull rod springs are hooked in the sockets, and the insertion end of each said pull rod spring is selectively inserted into one said insertion position;
an arc tip is arranged at the end, where the spindle is arranged, of the blade, a first clamping groove is formed in one side of the arc tip, a second clamping groove is formed in the other side of the arc tip, and under the action of the pull rod springs, a rod body of the pull rod keeps abutting against the arc tip;
handles are detachably mounted on outer surfaces of the liners, receding holes are formed in positions, corresponding to the sliding slots, of the handles, and second mounting clearances are reserved between inner surfaces of the handles and the liners and correspond to the pull rod springs.

2. The easy-to-maintain and elasticity-adjustable knife according to claim 1, wherein the handles are mounted on the liners with screws.

3. The easy-to-maintain and elasticity-adjustable knife according to claim 1, wherein a push button used by users to push the blade to rotate is arranged at a position close to a back of the blade, and the push button is uncovered.

4. The easy-to-maintain and elasticity-adjustable knife according to claim 3, wherein a top of the push button is mushroom-shaped and provided with a first anti-slip surface.

5. The easy-to-maintain and elasticity-adjustable knife according to claim 1, wherein second anti-slip surfaces are arranged on a back of the blade and side surfaces of the liners.

6. The easy-to-maintain and elasticity-adjustable knife according to claim 1, wherein a clip is arranged on one said handle.
